(19) United States
(12) Patent Application Publication
(10) Pub. No.: US 2025/0320008 A1
(43) Pub. Date: Oct. 16, 2025

(54) UNMANNED AERIAL VEHICLE CHARGING SYSTEM AND METHOD

(71) Applicant: Tru-Lock Technologies LLC, Charleston, SC (US)

(72) Inventors: Ashley Wilson Truluck, Charleston, SC (US); Kathryn Truluck Krogh, Charleston, SC (US)

(21) Appl. No.: 18/633,321

(22) Filed: Apr. 11, 2024

(51) Int. Cl. B64U 80/25; B60L 53/12; B60L 53/66; B60L 53/67

(52) U.S. Cl. CPC B64U 80/25; B60L 53/12; B60L 53/66; B60L 53/67; B60L 2200/10

(57) ABSTRACT

A system and method for secure charging and communications between an unmanned aerial vehicle (UAV) and at least one server or client device. Certain aspects of the present disclosure include at least one UAV and a charging station for providing a flow of power to the UAV to provide a charge to the UAV's battery. The charging station may be selectively configurable to provide the flow of power to the UAV according to one or more security permissions. If the UAV lacks the required permission, the charging station may be configured to restrict or block the flow of power to the UAV. The charging station may be further operable to establish a wireless or wireline data transfer interface between the charging station and the UAV according to the one or more security permissions.

### FIELD

The present disclosure relates to the field of unmanned aerial vehicle systems; in particular, an unmanned aerial vehicle charging system and communication network.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Certain aspects of the present disclosure provide for a system comprising an unmanned aerial vehicle; and a charging station comprising at least one power transfer interface configured to selectively deliver a flow of power to a battery of the unmanned aerial vehicle, wherein the charging station comprises a data transfer interface configured to selectively send and receive data between at least one first processor of the charging station and at least one second processor of the unmanned aerial vehicle, wherein the charging station is configured to receive at least one device identifier from the unmanned aerial vehicle, wherein, in response to receiving the at least one device identifier, the charging station is configured to deliver the flow of power to the battery of the unmanned aerial vehicle according to a first set of control parameters or restrict the flow of power to the battery of the unmanned aerial vehicle according to a second set of control parameters.

In accordance with certain embodiments of said system, the at least one power transfer interface comprises a wireless power transfer interface. In certain embodiments, the data transfer interface comprises a wireless data transfer interface. In accordance with certain aspects of the present disclosure, the system may further comprise at least one server communicably engaged with the charging station via at least one network interface. In said embodiments, the charging station may be configured to communicate the at least one device identifier to the at least one server via the at least one network interface, and the at least one server is configured to process the at least one device identifier according to the first set of control parameters and the second set of control parameters. In said embodiments, the system may further comprise at least one client device communicably engaged with the at least one server via the at least one network interface. In said embodiments, the at least one client device may be configured to configure the first set of control parameters and the second set of control parameters via at least one graphical user interface of an end user application. In certain embodiments the at least one first processor of the charging station, in response to receiving the at least one device identifier, may be configured to receive at least one data packet from the at least one second processor of the unmanned aerial vehicle according to a third set of control parameters. In said embodiments, the at least one data packet may comprise in-flight data for the unmanned aerial vehicle. In said embodiments, the charging station may be configured to communicate the in-flight data for the unmanned aerial vehicle to at least one end user device via at least one network interface.

Further aspects of the present disclosure provide for a system comprising an unmanned aerial vehicle; a charging station comprising at least one power transfer interface configured to selectively deliver a flow of power to a battery of the unmanned aerial vehicle; and at least one end user device communicably engaged with the charging station via at least one communications interface, wherein the at least one end user device is configured to configure a plurality of control parameters for the charging station, wherein the charging station is configured to selectively restrict or deliver the flow of power to the battery of the unmanned aerial vehicle according to the plurality of control parameters, wherein the charging station is configured to selectively block or establish a data transfer interface between the unmanned aerial vehicle and the charging station according to the plurality of control parameters.

In accordance with certain embodiments, the plurality of control parameters for the charging station may comprise a first set of charging permissions for the unmanned aerial vehicle and a first set of data transfer permissions for the unmanned aerial vehicle. In certain embodiments, the unmanned aerial vehicle may be configured to communicate a device identifier to the charging station and the charging station is configured to process the device identifier to identify the unmanned aerial vehicle. In said embodiments, the charging station may be configured to restrict the flow of power to the battery of the unmanned aerial vehicle when the device identifier lacks a permission according to the plurality of control parameters. In said embodiments, the charging station may be configured to block the data transfer interface between the unmanned aerial vehicle and the charging station when the device identifier lacks a permission according to the plurality of control parameters.

Still further aspects of the present disclosure may provide for a system comprising two or more unmanned aerial vehicles; and a first charging station comprising at least one power transfer interface, wherein the first charging station is configured to selectively restrict or deliver a first flow of power to a first unmanned aerial vehicle in the two or more unmanned aerial vehicles according to a first set of control parameters, wherein the first charging station is configured to selectively restrict or deliver a second flow of power to a second unmanned aerial vehicle in the two or more unmanned aerial vehicles according to a second set of control parameters.

In accordance with certain embodiments, the system may further comprise a second charging station, wherein the first charging station is communicably engaged with the second charging station via at least one network interface. In certain embodiments, the first set of control parameters may comprise at least one charging permission and data transfer permission for the first unmanned aerial vehicle, and the second set of control parameters may comprise at least one charging permission and data transfer permission for the second unmanned aerial vehicle. The first charging station may be configured to selectively block or establish a data transfer interface between the first unmanned aerial vehicle in the two or more unmanned aerial vehicles according to the first set of control parameters. In said embodiments, the first charging station may be configured to selectively block or establish a data transfer interface between the second unmanned aerial vehicle in the two or more unmanned aerial vehicles according to the second set of control parameters.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The skilled artisan will understand that the figures, described herein, are for illustration purposes only. It is to be understood that in some instances various aspects of the described implementations may be shown exaggerated or enlarged to facilitate an understanding of the described implementations. In the drawings, like reference characters generally refer to like features, functionally similar and/or structurally similar elements throughout the various drawings. The drawings are not necessarily to scale, emphasis instead being placed upon illustrating the principles of the teachings. The drawings are not intended to limit the scope of the present teachings in any way. The systems and methods of the present disclosure may be better understood from the following illustrative description with reference to the following drawings in which:

FIG. 1 is an architecture diagram of an unmanned aerial vehicle charging system, in accordance with certain aspects of the present disclosure;

FIGS. 2A-2B are functional diagrams of a charging interface between an unmanned aerial vehicle and a charging station, in accordance with certain aspects of the present disclosure;

FIG. 3 is a functional diagram of various operational permissions between one or more unmanned aerial vehicles and one or more charging stations, in accordance with certain aspects of the present disclosure;

FIG. 4 is a functional diagram of an unmanned aerial vehicle charging system, in accordance with certain aspects of the present disclosure;

FIG. 5 is a functional diagram of an unmanned aerial vehicle charging system, in accordance with certain aspects of the present disclosure;

FIG. 6 is a functional diagram of an unmanned aerial vehicle charging system, in accordance with certain aspects of the present disclosure;

FIG. 7 is a functional block diagram of an operational routine of an unmanned aerial vehicle charging system, in accordance with certain aspects of the present disclosure;

FIG. 8 is a functional block diagram of an operational routine of an unmanned aerial vehicle charging system, in accordance with certain aspects of the present disclosure;

FIG. 9 is a functional block diagram of an operational routine of an unmanned aerial vehicle charging system, in accordance with certain aspects of the present disclosure; and

FIG. 10 is an illustrative embodiment of a computing environment through which one or more aspects of the present disclosure may be implemented.

### DETAILED DESCRIPTION

It should be appreciated that all combinations of the concepts discussed in greater detail below (provided such concepts are not mutually inconsistent) are contemplated as being part of the inventive subject matter disclosed herein. It also should be appreciated that terminology explicitly employed herein that also may appear in any disclosure incorporated by reference should be accorded a meaning most consistent with the particular concepts disclosed herein.

Following below are more detailed descriptions of various concepts related to, and embodiments of, inventive methods, apparatus and systems related to novel charging system and network communications protocols for unmanned aerial vehicles (UAVs). Certain embodiments of the present disclosure include a charging station configured to operably interface with a UAV to provide a flow of power to an onboard charger of the UAV in order to charge the UAV's battery. The charging station may comprise a controller configured to identify the UAV and initiate or restrict the flow of power to the UAV according to one or more charging permissions for the UAV. The charging permissions may be configurable by a user and the charging station may be communicably engaged with one or more server or end user device to administer the charging permissions. In accordance with certain embodiments, the charging station may be further configured to configure a data transfer interface between the UAV and the charging station. The data transfer interface may be further configurable according to one or more data transfer permissions. As with the charging permissions, the data transfer permissions may be configured to facilitate or restrict the establishment of the data transfer interface between the UAV and the charging station.

It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes. The present disclosure should in no way be limited to the exemplary implementation and techniques illustrated in the drawings and described below.

Before the present invention and specific exemplary embodiments of the invention are described, it is to be understood that this invention is not limited to the particular embodiments described, and as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed by the invention. The upper and lower limits of these smaller ranges may independently be included in the smaller ranges, and are also encompassed by the invention, subject to any specifically excluded limit in a stated range. Where a stated range includes one or both of the endpoint limits, ranges excluding either or both of those included endpoints are also included in the scope of the invention.

As used herein, “exemplary” means serving as an example or illustration and does not necessarily denote ideal or best.

As used herein, the term “includes” means includes but is not limited to, the term “including” means including but not limited to. The term “based on” means based at least in part on.

As used herein, the term “interface” refers to any shared boundary across which two or more separate components of a computer system may exchange information. The exchange can be between software, computer hardware, peripheral devices, humans, and combinations thereof.

As used herein, the term “unmanned aerial vehicle” (UAV) refers to any powered, aerial vehicle that does not carry a human operator, uses aerodynamic forces to provide vehicle lift, can fly autonomously or be piloted remotely, can be expendable or recoverable, and can carry a lethal or nonlethal payload. The term “unmanned aerial vehicle” may be used interchangeably with the term “drone.”

Certain benefits and advantages of the present disclosure include systems and methods to provide for a secure charging network for UAVs to enable increased range of flight; for example, in a drone delivery network.

Certain benefits and advantages of the present disclosure include systems and methods to provide for a communications network to enable secure communications between a UAV and a remote server and/or client device via a network of one or more charging stations.

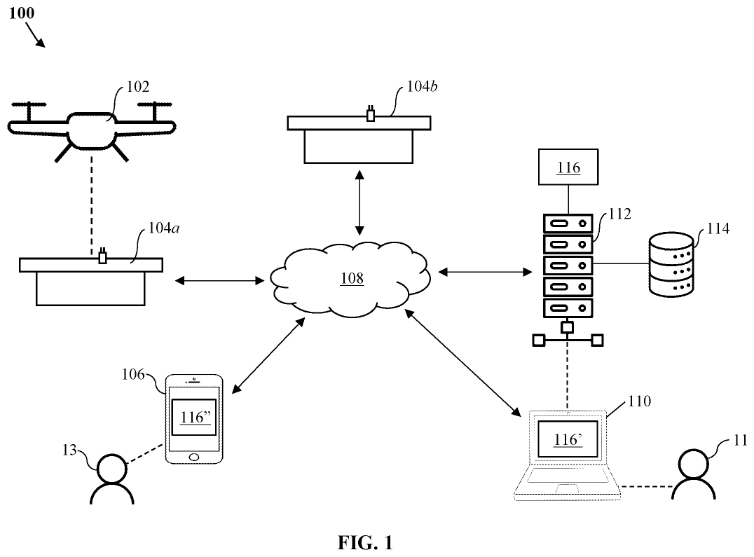

Turning now descriptively to the drawings, in which similar reference characters denote similar elements throughout the several views, FIG. 1 depicts an architecture diagram of an unmanned aerial vehicle charging system 100. In accordance with certain aspects of the present disclosure, system 100 comprises at least one UAV 102 and one or more charging station 104a and 104b. Charging stations 104a,b may be configured to provide a flow of power to UAV 102 in order to charge a battery of UAV 102. Charging stations 104a,b may comprise a planar upper surface configured as a landing pad to enable UAV 102 to land on top of charging stations 104a,b. Charging stations 104a,b may be communicable engaged with each other via a communications network 108. Communications network 108 may comprise a wireless and/or wireline communications network interface. In accordance with certain aspects of the present disclosure, system 100 may further comprise at least one application server 112 communicably engaged with charging stations 104a,b via communications network 108. Application server 112 may be communicably engaged with an application database 114. Application server 112 may be configured to host and execute a server-side instance of a control application 116. Control application 116 may comprise one or more processor-executable instructions for configuring, provisioning and executing a plurality of control parameters for charging stations 104a,b. In accordance with certain aspects of the present disclosure, the plurality of control parameters may comprise parameters for controlling one or more operations of charging stations 104a,b. The one or more operations may include operations for receiving a device identifier for UAV 102; processing the device identifier to determine one or more configured permissions for UAV 102; establishing a power transfer interface with UAV 102; initiating a flow of power to UAV 102; establishing a data transfer interface with UAV 102; and/or sending/receiving one or more data packets to/from UAV 102.

In accordance with certain embodiments, system 100 may further comprise at least one administrator client 110 and end user client 106. Administrator client 110 may be locally networked with application server 112 and/or may be remotely networked with application server 112 via communications network 108. Administrator client 110 may be configured to execute a client-side instance 116′ of control application 116. Client-side instance 116′ may comprise a graphical user interface comprising one or more elements configured to enable an administrator user 11 to selectively configure the plurality of control parameters for charging stations 104a,b via a plurality of user-generated inputs. The plurality of user-generated inputs may be pushed to application server 112 via one or more data transfer protocol (e.g., hypertext transfer protocol) and application server 112 may process the plurality of user-generated inputs according to one or more operations of control application 116 to configure the plurality of control parameters for charging stations 104a,b. Client-side instance 116′ may be further operable to receive data stored in application database 114 for UAV 102 including, for example, charging data, device activity data, in-flight data (e.g., telemetry data, audio/video data, sensor data, etc.), and the like. End user client 106 may be communicably engaged with application server 112 via communications network 108. End user client 106 may be configured to execute an end-user instance 116″ of control application 116. End-user instance 116″ may comprise a graphical user interface comprising one or more elements configured to enable an end user 13 to selectively configure the plurality of control parameters for charging stations 104a,b via a plurality of user-generated inputs. The plurality of user-generated inputs may be pushed to application server 112 via one or more data transfer protocol (e.g., hypertext transfer protocol) and application server 112 may process the plurality of user-generated inputs according to one or more operations of control application 116 to configure the plurality of control parameters for charging stations 104a,b. End user instance 116″ may be further operable to receive and view data stored in application database 114 for UAV 102 including, for example, charging data, device activity data, in-flight data (e.g., telemetry data, audio/video data, sensor data, etc.), and the like.

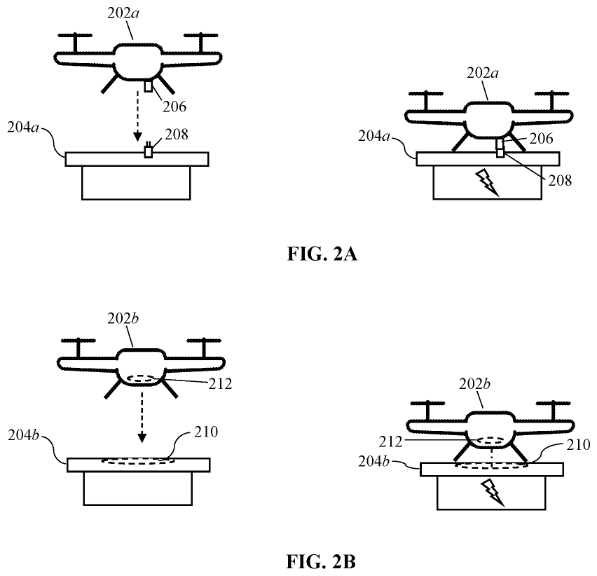

Referring now to FIGS. 2A-2B, functional diagrams of a charging interface between an unmanned aerial vehicle and a charging station are shown. FIG. 2A shows a UAV 202a and a charging station 204a. In accordance with certain aspects of the present disclosure, UAV 202a may comprise UAV 102 of system 100 (as shown in FIG. 1) and charging station 204a may comprise charging station 104a and/or charging station 104b of system 100 (as shown in FIG. 1). In accordance with an embodiment, FIG. 2A illustrates a physical charging interface via a first charging connector 206 of UAV 202a and a second charging connector 208 of charging station 204a. First charging connector 206 and second charging connector 208 may comprise a mating set of male/female magnetic power connectors, such that first charging connector 206 is configured to establish a magnetic, mateable interface when in proximity to second charging connector 208. As shown in FIG. 2A, UAV 202a is configured to land on an upper surface comprising a landing pad area of charging station 204a. Upon landing at a designated location on the upper surface of charging station 204a, first charging connector 206 is configured to establish an operable interface with second charging connector 208 to enable a power transfer interface between UAV 202a and charging station 204a. First charging connector 206 and second charging connector 208 may further comprise data connectors (e.g., a bus) to enable a data transfer interface between UAV 202a and charging station 204a.

FIG. 2B shows a UAV 202b and a charging station 204b. In accordance with certain aspects of the present disclosure, UAV 202b may comprise UAV 102 of system 100 (as shown in FIG. 1) and charging station 204b may comprise charging station 104a and/or charging station 104b of system 100 (as shown in FIG. 1). In accordance with an embodiment, FIG. 2B illustrates a wireless charging interface via a wireless power transmitter 210 disposed on (or operably adjacent to) an upper surface of charging station 204b and a wireless power receiver 212 housed in a body of UAV 202b. In said embodiments, UAV 202b is configured to land on the upper surface of charging station 204b to establish a functional proximity between wireless power transmitter 210 and wireless power receiver 212. Charging station 204b is configured to initiate a flow of power to the wireless power transmitter 210 according to one or more control parameters (as described in more detail herein) to establish the wireless charging interface between wireless power transmitter 210 and wireless power receiver 212. The components of wireless battery charging systems, such as those anticipated by FIG. 2B, are well-known in the art and need not be discussed at length here, for the sake of brevity.

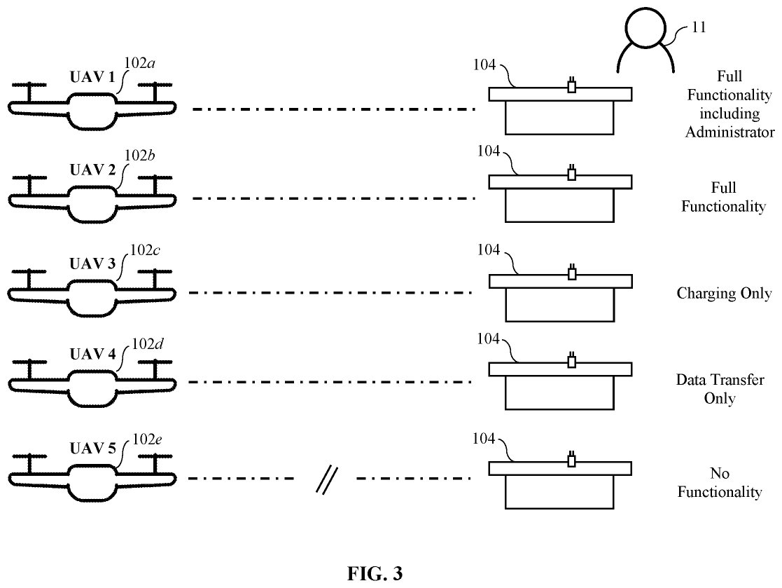

Referring now to FIG. 3 (with certain references to FIG. 1), a functional diagram of a plurality of operational modes between one or more unmanned aerial vehicles and one or more charging stations is shown. In accordance with certain aspects of the present disclosure, the plurality of operational modes in FIG. 3 may be implemented within the context of system 100, as shown in FIG. 1. In accordance with certain aspects of the present disclosure, an administrator user 11 may configure a plurality of control parameters via the client-side instance 116′ of control application 116 (as shown in FIG. 1) to enable the plurality of operational modes. In accordance with certain aspects of the present disclosure, the plurality of operational modes comprise a plurality of permissions for one or more UAVs to access one or more functions of a charging station 104. In accordance with certain aspects of the present disclosure, each UAV in the one or more UAVs may comprise a device identifier (ID). The device ID may be a unique device ID or may be a categorical type of device ID; e.g., a “type 1” device, a “type 2” device, etc. The charging station 104 may be configured to receive the device ID from an incoming UAV and process the device ID to determine the stored permissions for the incoming UAV in order to engage the charging station in the correct operational mode. In accordance with certain embodiments, the one or more UAVs may communicate the device ID to the charging station according to one or more modalities including, but not limited to, BLUETOOTH advertisement, radio frequency identification (RFID) tag, near-field communication (NFC), optical code (e.g., bar code), free-space optical transmission, and the like.

In accordance with certain aspects of the present disclosure, a first set of control parameters may comprise a first set of permissions for a first UAV 102a. In certain embodiments, the first set of control parameters may comprise an unrestricted set of permissions for first UAV 102a. The unrestricted set of permissions for first UAV 102a may support full functionality between first UAV 102a and charging station 104, including at least one administrator function. The full functionality may include one or more functions for establishing a power transfer interface between first UAV 102a and charging station 104 (e.g., for charging a battery of first UAV 102a). The full functionality may further include one or more functions for establishing a data transfer interface between first UAV 102a and charging station 104 (e.g., to enable bi-directional data transmission between first UAV 102a and charging station 104). The at least one administrator function may include one or more functions for provisioning one or more software updates for first UAV 102a and/or charging station 104.

In certain embodiments, a second set of control parameters may comprise a full functionality set of permissions for a second UAV 102b. The full functionality set of permissions for second UAV 102b may support full charging and data functionality between second UAV 102b and charging station 104. The full charging and data functionality may include one or more functions for establishing a power transfer interface between second UAV 102b and charging station 104 (e.g., for charging a battery of second UAV 102b). The full charging and data functionality may further include one or more functions for establishing a data transfer interface between second UAV 102b and charging station 104 (e.g., to enable bi-directional data transmission between second UAV 102b and charging station 104).

In certain embodiments, a third set of control parameters may comprise a first partially restricted set of permissions for a third UAV 102c. The first partially restricted set of permissions for third UAV 102c may support partially restricted functionality between third UAV 102c and charging station 104. The partially restricted functionality may include, for example, one or more functions for establishing a power transfer interface between third UAV 102c and charging station 104 (e.g., for charging a battery of third UAV 102c), while restricting or blocking establishment of a data transfer interface between third UAV 102c and charging station 104 (e.g., to block data transmission to/from third UAV 102c and charging station 104).

In certain embodiments, a fourth set of control parameters may comprise a second partially restricted set of permissions for a fourth UAV 102d. The second partially restricted set of permissions for fourth UAV 102d may support partially restricted functionality between fourth UAV 102d and charging station 104. The partially restricted functionality may include, for example, one or more functions for blocking a power transfer interface between fourth UAV 102d and charging station 104 (e.g., to block/restrict battery charging for the fourth UAV 102d), while enabling/establishing a data transfer interface between fourth UAV 102d and charging station 104 (e.g., to enable bi-directional data transmission between fourth UAV 102d and charging station 104).

In certain embodiments, a fifth set of control parameters may comprise a fully restricted set of permissions for a fifth UAV 102e. The fully restricted set of permissions for fifth UAV 102e may fully restrict any functionality between fifth UAV 102e and charging station 104. For example, the fifth set of control parameters may enable one or more functions for blocking a power transfer interface between fifth UAV 102e and charging station 104 (e.g., to block/restrict battery charging for the fifth UAV 102e), as well as restricting or blocking establishment of a data transfer interface between fifth UAV 102e and charging station 104 (e.g., to block data transmission to/from fifth UAV 102e and charging station 104).

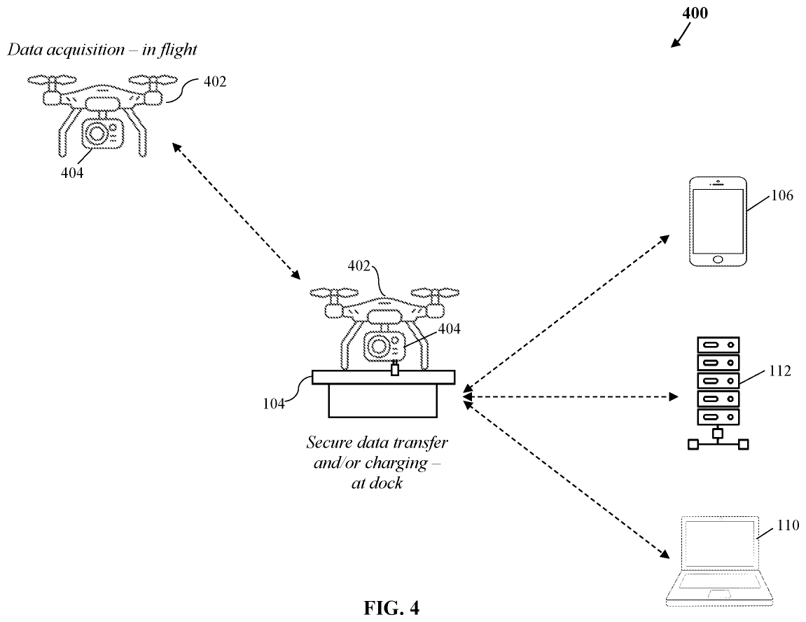

Referring now to FIG. 4, a functional diagram of an unmanned aerial vehicle charging system 400 is shown. In accordance with certain aspects of the present disclosure, system 400 may comprise an embodiment of system 100, as shown and described in FIG. 1. In accordance with certain aspects of the present disclosure, system 400 may enable a secure communications interface between a drone 402, charging station 104, end user client 106, application server 112, and administrator client 110. Drone 402 may comprise an embodiment of UAV 102, as shown in FIG. 1. Drone 402 may comprise an onboard camera 404 configured to collect and store digital video data during flight (i.e., in-flight data). System 400 may enable a secure communications environment for communicating in-flight data from drone 402 to one or more of end user client 106, application server 112, and administrator client 110. In accordance with certain aspects of the present disclosure, in-flight data is stored locally in a non-transitory computer readable storage medium of drone 402. In certain embodiments, the in-flight data is not transmitted as a real-time wireless digital data stream and drone 402 may not have any wireless communication capabilities. This enables an “air gap” between drone 402 and other computing devices to promote enhanced security for the in-flight data and flight controls; i.e., drone 402 cannot be remotely hacked by a malicious actor and the in-flight data cannot be intercepted during a wireless transmission. In certain embodiments, a flight path and in-flight operations for drone 402 are encoded in memory of drone 402 such that drone 402 is configured to fly and perform in-flight operations autonomously; e.g., without any input from a remote controller. Certain use cases for system 400 may include scenarios where high levels of data security are required, such as military and intelligence applications.

In accordance with certain aspects of the present disclosure, in response to completing one or more in-flight operations and collecting a plurality of in-flight data (e.g., via onboard camera 404), drone 402 is configured to land on a landing pad of charging station 104. Drone 402 may comprise a first power and data connector (e.g., as described in FIG. 2A) and charging station 104 may comprise a second power and data connector (e.g., as described in FIG. 2A). The first power and data connector and/or the second power and data connector may comprise at least one magnetic surface to facilitate a secure connection between the first power and data connector and the second power and data connector. The first power and data connector and the second power and data connector are configured to establish a power transfer interface and data bus between drone 402 and charging station 104. Upon establishing the interface between the first power and data connector and the second power and data connector, charging station 104 may be configured to receive at least one device ID from drone 402 in order to authenticate drone 402 according to one or more security parameters and permissions. Upon successfully authenticating drone 402, charging station 104 may be configured to initiate a flow of power (e.g., between the first power and data connector and the second power and data connector) to provide a charge to an on-board battery of drone 402 in accordance with one or more power transfer permissions. Upon successfully authenticating drone 402, charging station 104 may be further configured to initiate at least one data transfer protocol between a local memory storage device of drone 402 and a central processing unit of charging station 104. In certain embodiments, the at least one data transfer protocol may comprise at least one protocol for communicating the in-flight data from drone 402 to the central processing unit of charging station 104. The in-flight data may include video data, audio data, telemetry data, diagnostic data, and the like. In accordance with certain aspects of the present disclosure, charging station 104 is configured to communicate the in-flight data to one or more of end user client 106, application server 112 and/or administrator client 110 via a secure network interface. In accordance with certain aspects of the present disclosure, charging station 104 may be configured to receive one or more software updates for drone 402 via the secure network interface. The one or more software updates may include one or more updated operations for drone 402; for example, updated flight path and data acquisition instructions for one or more subsequent flight. Charging station 104 may be configured to communicate one or more data packets to drone 402 via the data transfer interface in order to provision drone 402 with the one or more software updates. Drone 402 may take off from the landing pad of charging station 104 upon completion of battery charging and/or completion of one or more data transfers between drone 402 and charging station 104.

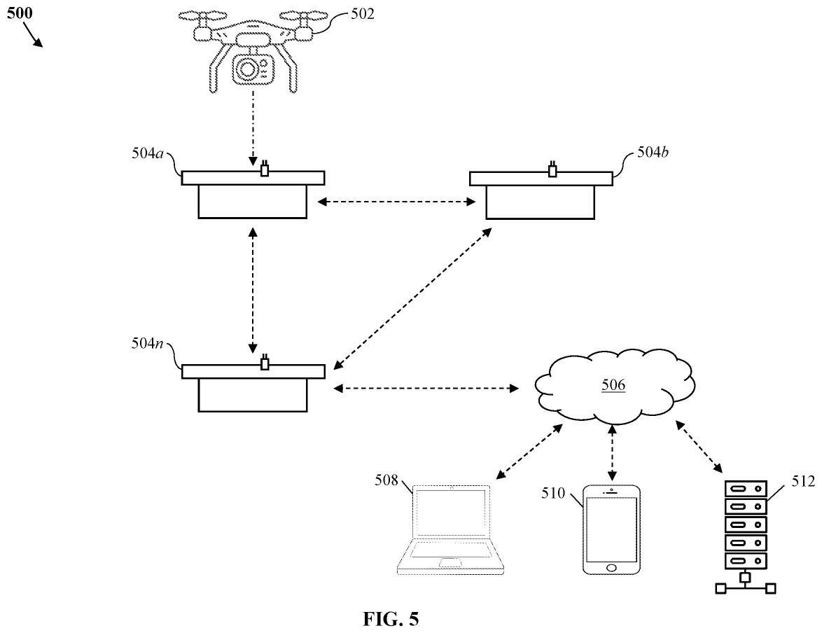

Referring now to FIG. 5, a functional diagram of an unmanned aerial vehicle charging system 500 is shown. In accordance with certain aspects of the present disclosure, system 500 may comprise an embodiment of system 100, as shown and described in FIG. 1. System 500 may further comprise an alternative embodiment of system 400, as shown in FIG. 4. In accordance with certain aspects of the present disclosure, system 500 may comprise a drone charging and communications network comprising at least one drone 502 and a plurality of charging stations 504a-n. Drone 502 may comprise an embodiment of UAV 102 of system 100, as shown and described in FIG. 1. Charging stations 504a-n may comprise an embodiment of charging station 104, as shown and described in FIG. 1.

Drone 502 may comprise an on-board camera and/or other on-board sensors for capturing in-flight data according to one or more modalities. In-flight data may be stored on a local storage medium of drone 502. In accordance with certain aspects of the present disclosure, charging stations 504a-n may be geographically spaced apart across a specified geographic area. In certain embodiments, charging stations 504a-n may be spaced apart according to a flight range of drone 502. For example, if drone 502 is capable of flying three miles on a battery charge, each of charging stations 504a-n may be spaced apart by approximately three miles. In said embodiments, charging stations 504a-n comprise a drone charging network configured to sequentially charge a battery of drone 502 to enable drone 502 to increase its flight range. Certain use cases in which system 500 may be implemented include drone delivery networks; for example, in cases where a payload needs to be delivered to a location that is farther than the battery range of the drone. In certain embodiments, charging stations 504a-n may include an array of solar cells arranged on a surface of the landing area. The solar cells may be operably engaged with a battery bank of the charging station. The solar cells may be configured to trickle charge the battery bank during daylight hours. The battery bank may, in turn, be configured to deliver a rapid charge to an on-board battery of drone 502 via a power transfer interface.

In accordance with certain aspects of the present disclosure, drone 502 may land on a landing area of a first charging station 504a. Drone 502 may communicate a device ID to charging station 504a via one or more modalities. Charging station 504a may process the device ID according to a first set of parameters to determine one or more functional permissions for drone 502 (e.g., as described in FIG. 3). Charging station 504a may selectively establish a charging interface and/or a data transfer interface with drone 502 in accordance with the one or more functional permissions. In accordance with certain aspects of the present disclosure, in-flight data stored on drone 502 may downloaded to charging station 504a via a central processing unit of charging station 504a. The in-flight data may be communicated between charging station 504a and one or more of charging station 504b and/or charging station 504n in accordance with one or more network communications protocols via a network communications interface. The in-flight data may further be communicated between charging station 504a and one or more client device 508, end user device 510 and/or application server 512 via a communications network 506. In certain embodiments, at least one charging station (e.g., charging station 504n) may be configured as a broker station between application server 512 and one or more other charging stations (e.g., charging stations 504a-b). In said embodiments, charging stations 504a-n may be configured as a mesh network to enable an increased range of communications between a gateway charging station and one or more node charging stations.

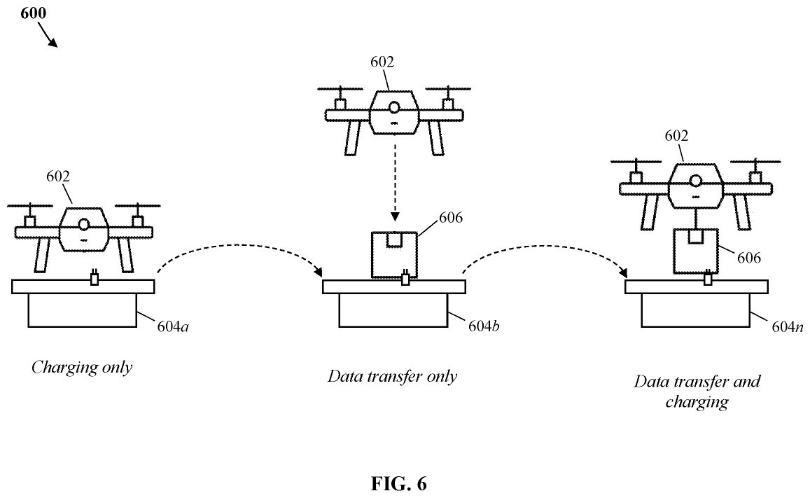

Referring now to FIG. 6, a functional diagram of an unmanned aerial vehicle charging system 600 is shown. In accordance with certain aspects of the present disclosure, system 600 may comprise an embodiment of system 100, as shown and described in FIG. 1. System 600 may further comprise an alternative embodiment of system 400, as shown in FIG. 4, and/or an embodiment of system 500, as shown in FIG. 5. In accordance with certain aspects of the present disclosure, system 600 may comprise a drone delivery network comprising a drone 602 and a plurality of charging stations 604a-n. Drone 602 may comprise an embodiment of UAV 102 of system 100, as shown and described in FIG. 1. Charging stations 604a-n may comprise an embodiment of charging station 104, as shown and described in FIG. 1. In accordance with certain aspects, system 600 may comprise a drone delivery network. In certain embodiments, system 600 may be configured wherein drone 602 may comprise differing permissions between each of charging stations 604a-n in the drone delivery network. For example, charging station 604a may be configured according to a first set of parameters to provide only a charging functionality to drone 602 (e.g., when drone 602 is operably interfaced with charging station 604a). In accordance with certain embodiments, drone 602 may be operably controlled to fly to a second charging station 604b to retrieve a payload 606. In accordance with certain aspects of the present disclosure, charging station 604b may be configured according to a second set of parameters to provide only a data transfer interface with drone 602 (e.g., to confirm payload 606 has been retrieved). In accordance with certain embodiments, drone 602 may be operably controlled to fly to a third charging station 604n to deliver payload 606. In accordance with certain aspects of the present disclosure, charging station 604n may be configured according to a third set of parameters to provide both a power transfer interface (e.g., to charge a battery of drone 602) and a data transfer interface with drone 602 (e.g., to confirm payload 606 has been delivered). In accordance with certain aspects of the present disclosure, charging station 604n may be configured to communicate one or more commands to drone 602 in response to confirming payload 606 has been delivered (e.g., providing instructions for pickup and delivery of the next payload in the drone delivery network). In accordance with certain aspects of the present disclosure, system 600 enables an autonomous drone delivery network without the need of human operators.

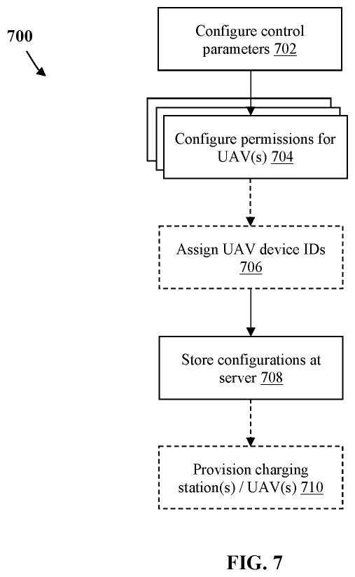

Referring now to FIG. 7, a functional block diagram of an operational routine 700 of an unmanned aerial vehicle charging system is shown. In accordance with certain aspects of the present disclosure, routine 700 may be implemented within system 100 of FIG. 1. The operations in routine 700 may be performed in the order presented, in a different order, or simultaneously. Further, in some exemplary embodiments, some of the operations may be omitted, added, modified, skipped, or the like without departing from the scope of the invention.

In accordance with certain aspects of the present disclosure, routine 700 may comprise one or more steps or operations for configuring (e.g., with an application server) one or more control parameters for one or more operational modes of a UAV charging station (Step 702). In certain embodiments, Step 702 may comprise one or more steps or operations for configuring (e.g., with the application server) the one or more control parameters according to at least one user-generated input via at least one client device. The one or more operational modes of the UAV charging station may comprise at least one power transfer mode, at least one data transfer mode, and at least one power and data transfer mode. In accordance with certain embodiments, the one or more control parameters may comprise one or more control parameters as shown and described in FIG. 3. Routine 700 may proceed by executing one or more steps or operations for configuring (e.g., with the application server) one or more permissions for one or more UAVs (Step 704). In certain embodiments, the one or more permissions may comprise specific control parameters for one or more UAV in a UAV device network. In certain embodiments, routine 700 may optionally comprise one or more steps or operations for assigning (e.g., with the application server) one or more UAV device IDs to one or more UAV in a UAV device network (Step 706). Routine 700 may proceed by executing one or more steps or operations for storing the one or more configured parameters and permissions (and, optionally, UAV device IDs) at the application server (Step 708). Routine 700 may optionally comprise one or more steps or operations for provisioning one or more charging station and/or UAV with the configured parameters and permissions, and optionally with the UAV device IDs (Step 710).

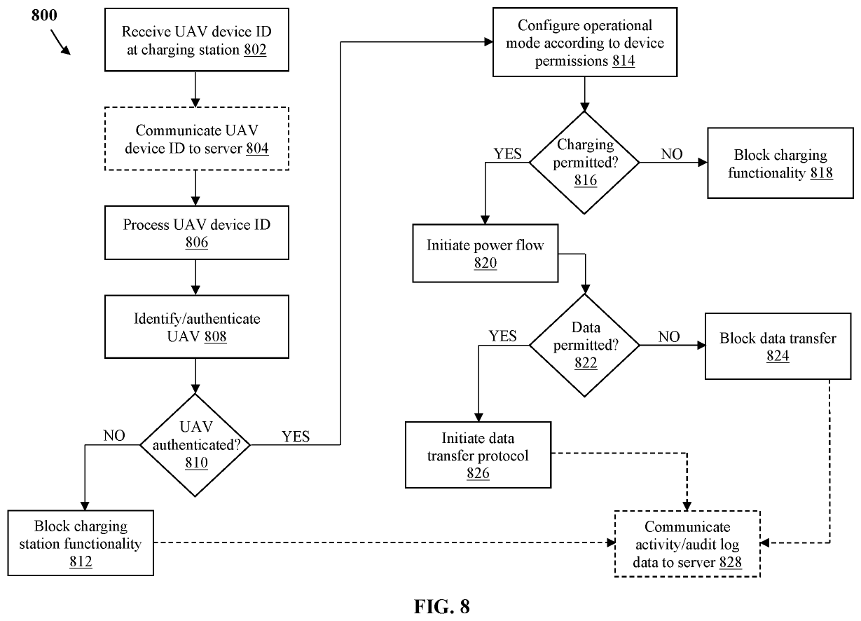

Referring now to FIG. 8, a functional block diagram of an operational routine 800 of an unmanned aerial vehicle charging system is shown. In accordance with certain aspects of the present disclosure, routine 800 may be implemented within system 100 of FIG. 1. The operations in routine 800 may be performed in the order presented, in a different order, or simultaneously. Further, in some exemplary embodiments, some of the operations may be omitted, added, modified, skipped, or the like without departing from the scope of the invention. In certain embodiments, one or more operations in routine 800 may be successive or sequential to one or more operations of routine 700 of FIG. 7.

In accordance with certain aspects of the present disclosure, routine 800 may comprise one or more steps or operations for receiving a UAV device ID at a charging station of the UAV charging system from at least one UAV (Step 802). The charging station may receive the UAV device ID via one or more modality including, for example, BLUETOOTH advertisement, radio frequency identification (RFID) tag, near-field communication (NFC), optical code (e.g., bar code), free-space optical transmission, and the like. In certain embodiments, routine 800 may optionally comprise one or more steps or operations for communicating the UAV device ID to a server via a network communications interface (Step 804). Routine 800 may proceed by executing one or more steps or operations for processing the UAV device ID according to one or more data processing parameters (Step 806). Step 806 may be executed, at least partially, at a central processing unit of the charging station and/or may be executed, at least partially, at the server. Routine 800 may proceed by executing one or more steps or operations to identify and/or authenticate the least one UAV according to an output of Step 806 (Step 808). Routine 800 may proceed by executing one or more steps or operations associated with at least one decision step 810 to determine whether the at least one UAV is identified and authenticated according to the one or more data processing parameters. If NO (i.e., the UAV is not identified or authenticated according to the one or more data processing parameters), then routine 800 proceeds by executing one or more steps or operations for blocking or restricting all functionality for the charging station (Step 812). If YES (i.e., the UAV has been successfully identified or authenticated according to the one or more data processing parameters), then routine 800 proceeds by executing one or more steps or operations for configuring an operational mode of the charging station according to one or more device permissions for the at least one UAV (Step 814). In accordance with certain aspects of the present disclosure, routine 800 may execute one or more of steps 816-826 to configure the charging station in the correct operational mode. In certain embodiments, routine 800 may comprise one or more steps or operations associated with at least one decision step 816 to determine whether a charging function of the charging station is permitted according to the one or more device permissions for the at least one UAV. If NO (i.e., the charging function of the charging station is not permitted according to the one or more device permissions for the at least one UAV), then routine 800 proceeds by executing one or more steps or operations for blocking the charging function of the charging station (Step 818). If YES (i.e., the charging function of the charging station is permitted according to the one or more device permissions for the at least one UAV), then routine 800 proceeds by executing one or more steps or operations for initiating a flow of power between the charging station and the at least one UAV via a power transfer interface (Step 820).

In certain embodiments, routine 800 may comprise one or more steps or operations associated with at least one decision step 822 to determine whether a data transfer function of the charging station is permitted according to the one or more device permissions for the at least one UAV. If NO (i.e., the data transfer function of the charging station is not permitted according to the one or more device permissions for the at least one UAV), then routine 800 proceeds by executing one or more steps or operations for blocking the data transfer function of the charging station (Step 824). If YES (i.e., the data transfer function of the charging station is permitted according to the one or more device permissions for the at least one UAV), then routine 800 proceeds by executing one or more steps or operations for initiating a data transfer protocol between the charging station and the at least one UAV via a data transfer interface (Step 826). In accordance with certain embodiments, routine 800 may optionally comprise one or more steps or operations for communicating charging station activity data and/or audit log data to the server via at least one network communications protocol (Step 828).

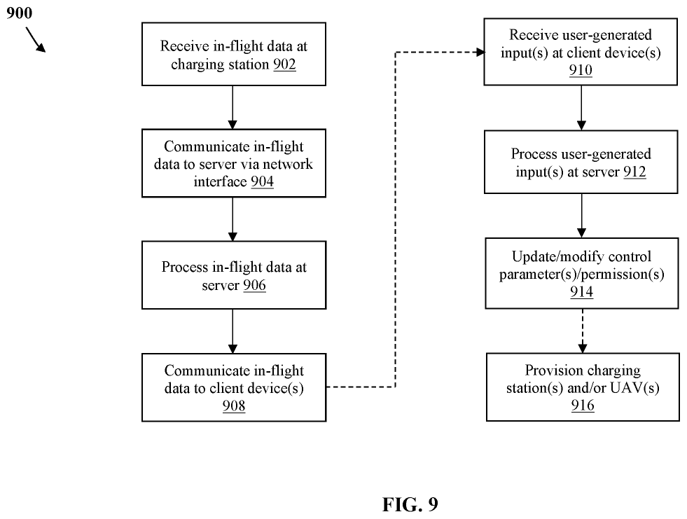

Referring now to FIG. 9, a functional block diagram of an operational routine 900 of an unmanned aerial vehicle charging system is shown. In accordance with certain aspects of the present disclosure, routine 900 may be implemented within system 100 of FIG. 1. The operations in routine 900 may be performed in the order presented, in a different order, or simultaneously. Further, in some exemplary embodiments, some of the operations may be omitted, added, modified, skipped, or the like without departing from the scope of the invention. In certain embodiments, one or more operations in routine 900 may be successive or sequential to one or more operations of routine 700 of FIG. 7 and/or routine 800 of FIG. 8.

In accordance with certain aspects of the present disclosure, routine 900 may comprise one or more steps or operations for receiving in-flight data from at least one UAV at a charging station of an unmanned aerial vehicle charging system (Step 902). The in-flight data may comprise video data, audio data, telemetry data, environmental sensor data, and the like. Routine 900 may proceed by executing one or more steps or operations for communicating the in-flight data from the charging station to at least one server via a network communications interface (e.g., in accordance with at least one network communications protocol) (Step 904). Routine 900 may proceed by processing the in-flight data at the server according to one or more data processing protocols (Step 906). Step 906 may further comprise one or more steps or operations for storing the in-flight data in at least one database communicably engaged with the application server. Routine 900 may further comprise one or more steps or operations for communicating all or part of the in-flight data to one or more client devices via at least one network communications protocol (Step 908). In certain embodiments, one or more steps or operations of Step 908 may be performed pursuant to one or more query or request received at the one or more client devices. In accordance with certain aspects of the present disclosure, routine 900 may optionally proceed by executing one or more steps or operations for receiving one or more user-generated input from the one or more client devices at the server (Step 910) and processing the one or more user-generated input according to at least one data processing framework (Step 912). Routine 900 may proceed (e.g., in accordance with an output of Step 912) by executing one or more steps or operations for updating, modifying and/or configuring the control parameters and/or device permissions for the one or more UAVs based on the one or more user-generated input received at step 910 (Step 914). Routine 900 may optionally proceed by executing one or more steps or operations for provisioning the charging system and/or the at least one UAV with one or more software update or data packet according to an output of step 914 (Step 916).

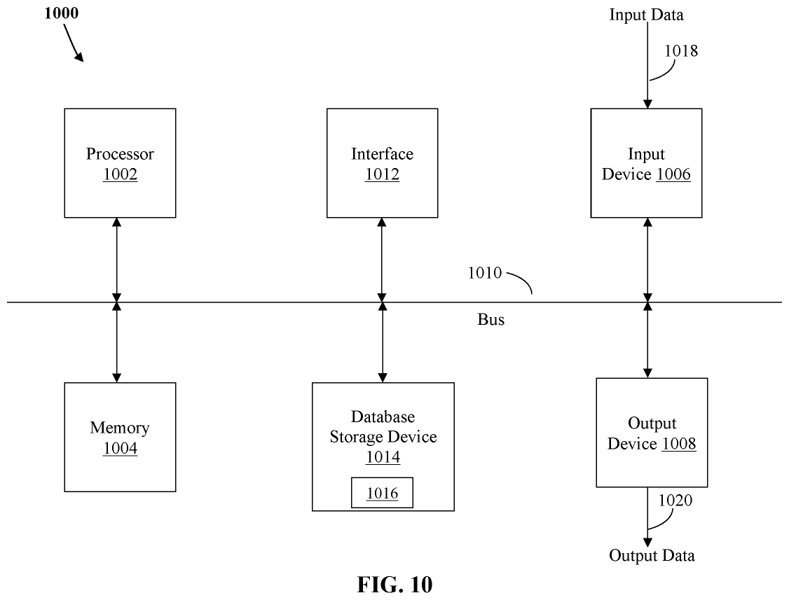

Referring now to FIG. 10, a processor-implemented computing system 1000 through which one or more aspects of the present disclosure may be implemented is shown. According to an embodiment, system 1000 may generally comprise at least one processor 1002, or processing unit or plurality of processors, memory 1004, at least one input device 1006 and at least one output device 1008, coupled together via a bus or group of buses 1010. In certain embodiments, input device 1006 and output device 1008 could be the same device. An interface 1012 can also be provided for coupling system 1000 to one or more peripheral devices, for example interface 1012 could be a PCI card or PC card. At least one storage device 1014 which houses at least one database 1016 can also be provided. The memory 1004 can be any form of memory device, for example, volatile or non-volatile memory, solid state storage devices, magnetic devices, etc. The processor 1002 could comprise more than one distinct processing device, for example to handle different functions within system 1000. Input device 1006 receives input data 1018 and can comprise, for example, a keyboard, a pointer device such as a pen-like device or a mouse, audio receiving device for voice-controlled activation such as a microphone, data receiver or antenna such as a modem or wireless data adaptor, data acquisition card, etc. Input data 1018 could come from different sources, for example keyboard instructions in conjunction with data received via a network. Output device 1008 produces or generates output data 1020 and can comprise, for example, a display device or monitor in which case output data 1020 is visual, a printer in which case output data 1020 is printed, a port for example a USB port, a peripheral component adaptor, a data transmitter or antenna such as a modem or wireless network adaptor, etc. Output data 1020 could be distinct and derived from different output devices, for example a visual display on a monitor in conjunction with data transmitted to a network. A user could view data output, or an interpretation of the data output, on, for example, a monitor or using a printer. The storage device 1014 can be any form of data or information storage means, for example, volatile or non-volatile memory, solid state storage devices, magnetic devices, etc.

In use, system 1000 is adapted to allow data or information to be stored in and/or retrieved from, via wired or wireless communication means, at least one database 1016. The interface 1012 may allow wired and/or wireless communication between the processing unit 1002 and peripheral components that may serve a specialized purpose. In general, the processor 1002 can receive instructions as input data 1018 via input device 1006 and can display processed results or other output to a user by utilizing output device 1008. More than one input device 1006 and/or output device 1008 can be provided. It should be appreciated that system 1000 may be any form of terminal, server, specialized hardware, or the like.

It is to be appreciated that system 1000 may be a part of a networked communications system. System 1000 could connect to a network, for example the Internet or a WAN. Input data 1018 and output data 1020 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, system 1000 illustrated in FIG. 10 may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 10 include a local area network (LAN) and a wide area network (WAN) but may also include other networks such as a personal area network (PAN). Such networking environments are commonplace in offices, enterprise-wide computer networks, intranets, and the Internet. For instance, when used in a LAN networking environment, system 1000 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to system 1000, or portions thereof, may be stored in a remote memory storage device. It is to be appreciated that the illustrated network connections of FIG. 10 are exemplary and other means of establishing a communications link between multiple computers may be used.

FIG. 10 is intended to provide a brief, general description of an illustrative and/or suitable exemplary environment in which embodiments of the present disclosure may be implemented. FIG. 10 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as system 1000 of FIG. 10. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It is noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

Any publications discussed herein are provided solely for their disclosure prior to the filing date of the present application. Nothing herein is to be construed as an admission that the present invention is not entitled to antedate such publication by virtue of prior invention. Further, the dates of publication provided may differ from the actual publication dates which may need to be independently confirmed.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational phases to be performed on the computer or other programmable apparatus to produce a computer-implemented process such that the code portions which execute on the computer or other programmable apparatus provide phases for implementing the functions/acts specified in the flowchart and/or block diagram block(s). Alternatively, computer program implemented phases or acts may be combined with operator or human implemented phases or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that phases of the processes described herein may be performed in orders different than those illustrated in the flowcharts. In other words, the processes represented by the blocks of a flowchart may, in some embodiments, be performed in an order other than the order illustrated, may be combined or divided, or may be performed simultaneously. It will also be understood that the blocks of the block diagrams illustrate, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While certain exemplary embodiments have been described and shown in the accompanying drawings, it is to be understood that such embodiments are merely illustrative of, and not restrictive on, the broad invention, and that this invention is not limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system comprising:
an unmanned aerial vehicle; and
a charging station comprising at least one power transfer interface configured to selectively deliver a flow of power to a battery of the unmanned aerial vehicle,
wherein the charging station comprises a data transfer interface configured to selectively send and receive data between at least one first processor of the charging station and at least one second processor of the unmanned aerial vehicle,
wherein the charging station is configured to receive at least one device identifier from the unmanned aerial vehicle,
wherein, in response to receiving the at least one device identifier, the charging station is configured to deliver the flow of power to the battery of the unmanned aerial vehicle according to a first set of control parameters or restrict the flow of power to the battery of the unmanned aerial vehicle according to a second set of control parameters.

2. The system of claim 1 wherein the at least one power transfer interface comprises a wireless power transfer interface.

3. The system of claim 1 wherein the data transfer interface comprises a wireless data transfer interface.

4. The system of claim 1 further comprising at least one server communicably engaged with the charging station via at least one network interface.

5. The system of claim 4 wherein the charging station is configured to communicate the at least one device identifier to the at least one server via the at least one network interface, and the at least one server is configured to process the at least one device identifier according to the first set of control parameters and the second set of control parameters.

6. The system of claim 4 further comprising at least one client device communicably engaged with the at least one server via the at least one network interface.

7. The system of claim 6 wherein the at least one client device is configured to configure the first set of control parameters and the second set of control parameters via at least one graphical user interface of an end user application.

8. The system of claim 1 wherein, in response to receiving the at least one device identifier, the at least one first processor of the charging station is configured to receive at least one data packet from the at least one second processor of the unmanned aerial vehicle according to a third set of control parameters.

9. The system of claim 8 wherein the at least one data packet comprises in-flight data for the unmanned aerial vehicle.

10. The system of claim 9 wherein the charging station is configured to communicate the in-flight data for the unmanned aerial vehicle to at least one end user device via at least one network interface.

11. A system comprising:
an unmanned aerial vehicle;
a charging station comprising at least one power transfer interface configured to selectively deliver a flow of power to a battery of the unmanned aerial vehicle; and
at least one end user device communicably engaged with the charging station via at least one communications interface,
wherein the at least one end user device is configured to configure a plurality of control parameters for the charging station,
wherein the charging station is configured to selectively restrict or deliver the flow of power to the battery of the unmanned aerial vehicle according to the plurality of control parameters,
wherein the charging station is configured to selectively block or establish a data transfer interface between the unmanned aerial vehicle and the charging station according to the plurality of control parameters.

12. The system of claim 11 wherein the plurality of control parameters for the charging station comprise a first set of charging permissions for the unmanned aerial vehicle and a first set of data transfer permissions for the unmanned aerial vehicle.

13. The system of claim 11 wherein the unmanned aerial vehicle is configured to communicate a device identifier to the charging station and the charging station is configured to process the device identifier to identify the unmanned aerial vehicle.

14. The system of claim 13 wherein the charging station is configured to restrict the flow of power to the battery of the unmanned aerial vehicle when the device identifier lacks a permission according to the plurality of control parameters.

15. The system of claim 13 wherein the charging station is configured to block the data transfer interface between the unmanned aerial vehicle and the charging station when the device identifier lacks a permission according to the plurality of control parameters.

16. A system comprising:
two or more unmanned aerial vehicles; and
a first charging station comprising at least one power transfer interface,
wherein the first charging station is configured to selectively restrict or deliver a first flow of power to a first unmanned aerial vehicle in the two or more unmanned aerial vehicles according to a first set of control parameters,
wherein the first charging station is configured to selectively restrict or deliver a second flow of power to a second unmanned aerial vehicle in the two or more unmanned aerial vehicles according to a second set of control parameters.

17. The system of claim 16 further comprising a second charging station, wherein the first charging station is communicably engaged with the second charging station via at least one network interface.

18. The system of claim 16 wherein the first set of control parameters comprises at least one charging permission and data transfer permission for the first unmanned aerial vehicle and the second set of control parameters comprises at least one charging permission and data transfer permission for the second unmanned aerial vehicle.

19. The system of claim 16 wherein the first charging station is configured to selectively block or establish a data transfer interface between the first unmanned aerial vehicle in the two or more unmanned aerial vehicles according to the first set of control parameters.

20. The system of claim 19 wherein the first charging station is configured to selectively block or establish a data transfer interface between the second unmanned aerial vehicle in the two or more unmanned aerial vehicles according to the second set of control parameters.
